(19) United States
(12) Patent Application Publication
(10) Pub. No.: US 2015/0154891 A1
(43) Pub. Date: Jun. 4, 2015

(54) Whiteboard With A Unique Attaching/Looping Device

(71) Applicant: Robert Baschnagel, Garden City, NY (US)

(72) Inventor: Robert Baschnagel, Garden City, NY (US)

(21) Appl. No.: 14/093,514

(22) Filed: Dec. 1, 2013

(51) Int. Cl. G09F 3/02; B43L 1/00; G09F 3/14

(52) U.S. Cl. CPC G09F 3/02; G09F 3/14; B43L 1/00; G09F 2003/0254

(57) ABSTRACT

The present invention relates to an attachable mini whiteboard with a unique attachment loop that can attach the mini whiteboard to any items including but not limited to a doorknob, furniture, luggage, plumbing pipe and that can be bent to stand on a flat surface including but not limited to a desk to support the mini whiteboard in a right-up position.

### REFERENCE TO RELATED APPLICATIONS

This patent application claims the benefit of U.S. Provisional Application No. 61/871,855 filed on Aug. 29, 2013, the disclosure of which is incorporated herein by reference in its entirety.

### BACKGROUND OF THE INVENTION

1. Field of the Invention

The present invention generally relates to portable mini dry erase writing boards or portable mini whiteboards and more particularly to an apparatus that has the specific features of acting as a whiteboard for creating messages that are easily erased and drafted upon a portable mini whiteboard that is structured with a unique attachment loop located on the mini whiteboard itself.

2. Description of Related Art

Sometimes, a message left on a piece of paper or post-it may not be obvious and easily missed. Consequently it is necessary to have an easy way to leave messages without needing to write on a piece of paper.

A whiteboard is a name given to a dry-wipe board, similar in usage to a chalk board. The surface is usually a glossy white and allows for nonpermanent markings and easy erasing. Whiteboards can come in different sizes and shapes and are used for presentations of information in many different locations such as schools or office meetings. Whiteboards can be mounted on a permanent surface or on a moveable structure. Whiteboards can also be made in smaller versions to serve an individual. Such versions are light and portable.

As an alternative to a chalk board there is the popular use of a white marker board. The name whiteboard is a misnomer as the actual color of the board can be white (or light shades of tan). Such a board is generally a vertically mounted writing surface, that is written upon with felt-tipped pens, and that dispense a contrasting color ink that “dries” on the board. The writing is of a non-permanent ink which when “erased” becomes a loose dust that is removed from the board with the use of an eraser.

Typically, a white board was erased with a traditional felt type eraser, which was originally designed for use on traditional black slate boards.

Although boards with erasable surfaces are available, such boards are not equipped with an attachment loop for hanging on a doorknob or handle of furniture or supporting itself on a flat surface. Thus, it may be left flat on a desk or table which is crowded with a bunch of other stuff and thus is easily neglected. Sometimes, if a person needs to leave a message for another to see when they are out a whiteboard available in the market has no place to put on a door.

Thus, a mini whiteboard with a unique bendable attachment loop solving the aforementioned problem is desired.

Yet throughout all the years of usage a very small pocket sized whiteboard that has a looping or attaching mechanism associated with the board itself does not exist.

Such a looping mechanism is described herein along with its rather unique features. While such a device is used in this patent in conjunction with a whiteboard, it is noted that said looping device could in theory attach and be associated with such other devices of similar size but not necessarily similar nature. One such example would be the unique looping device associated herein being attached to a hand sized pill box for ease of hanging or looping over door handles, closed or open as the case may be—either a door knob or a semi circular loop handle that needs for a wire to loop around said handle.

What is needed for usage within hotel room doors, office building doors, file cabinets, etc. is an apparatus that serves as a whiteboard but is portable, can be attached to a book to door handle or looped around the handle of a desk draw that is not easy to secure a tagging system there onto.

### SUMMARY OF THE INVENTION

In an exemplary embodiment of the present invention, there is disclosed an attachable mini whiteboard with a unique attachment loop of which the attachment loop flexes and stays in positions as it is bent. It could have a built in marker tip or the marker could be attached to the board. It could be turned over and flexed into a desk stand sign. For example, leaving a note on an office desk indicates that “I will be back at my desk within the hour”.

Additionally, this attachable mini whiteboard could also be made into a mini labeling tag for luggage and plumbing pipes where a plumber needs to put a note associated with a certain pipe, etc.

Effectively, anywhere that a message or information is needed this attachable mini whiteboard with the unique re-bendable attachment loop could be used.

The main focus of the present invention was the re-bendable loop which holds the whiteboard either on the handle or when placed on a flat surface such as a desk.

The present invention comprises a dry erase board or “whiteboard” and a U-shaped re-bendable wire. In one embodiment, the whiteboard has a writing surface on one side thereof and a non-writing surface on an opposite side thereof. In another embodiment, the whiteboard has writing surfaces on both sides.

An attachable mini whiteboard with an attachment loop according to one embodiment of the present invention comprises a mini whiteboard having opposed front and back sides, a dry erase writing surface on the front side, a groove along an edge of the whiteboard for holding a dry erase marker in place, and a receiving port or opening for receiving the attachment loop; and a substantially U-shaped attachment loop having a first end and a second end, the first end being connected to a side that the receiving port is located and the second end having a complementarily shaped structure of the receiving port at the whiteboard in order to mate and engage the receiving port at the whiteboard; wherein the attachment loop has a re-bendable or flexible wire covered by soft rubber like resilient material or foam so that the attachment loop is bendable and can change shape as needed to fit mounting surface. The attachment loop can stay in straight for hanging over a doorknob or bent to stay on a flat surface.

The mini whiteboard may be made in one of a variety of sizes and shapes. In one preferred embodiment, the mini whiteboard is substantially rectangular with rounded corners. In one embodiment, the whiteboard has a writing surface on its front side thereof on which the end user may erasably write down their messages by application of a dry erase maker and a non-writing surface on an opposite side thereof. In another embodiment, the whiteboard 10 has writing surfaces on both sides.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is an isometric front view of an attachable mini whiteboard which has a mini whiteboard and a unique attachment loop attached to the body of the whiteboard where notes are written and the attachment loop is in a closed position according to one embodiment of the present invention.

FIG. 2 is a close up view of the attachable mini whiteboard of FIG. 1 showing that the attachment loop is in a closed position and flush with the top portion of the whiteboard and the attachment loop is made from a flexible (or bendable) wire encased by soft rubber-like resilient material or foam.

FIG. 3 is a close up view of the attachable mini whiteboard of FIG. 1 showing that the attachment loop is in an open position and bendable and the second end of the loop has complimentarily shaped structure to mate with (or engage) the receiving port on the whiteboard.

FIG. 4 is an isometric back view of the attachable mini whiteboard of FIG. 1.

FIG. 5 is a front view showing that the attachable mini whiteboard of FIG. 1 is hanging on a doorknob.

FIG. 6 is a front view showing that the attachment loop of the attachable mini whiteboard of FIG. 1 is bent and stays on the desk to support the mini whiteboard.

FIG. 7 is an isometric front view of an attachable mini whiteboard according to another embodiment of the present invention which is in an unlocked position.

FIG. 8 is an isometric front view of the attachable mini whiteboard of FIG. 7 which is in a locked position.

FIG. 9 is an isometric front view of the attachable mini whiteboard of FIG. 7 of which the attachment loop is bent and stays on a desk to support the mini whiteboard.

FIG. 10 is a front view of the attachable mini whiteboard of FIG. 7 hangs on a handle of a cabinet in a unlocked position.

FIG. 11 is a front view of the attachable mini whiteboard of FIG. 7 hangs on a handle of a cabinet in a locked position.

FIG. 12 is a view of the attachable mini whiteboard of the present invention hangs on luggage.

FIG. 13 is a view of the attachable mini whiteboard of the present invention hangs on a plumbing pipe.

### DESCRIPTION OF THE PREFERRED EMBODIMENT

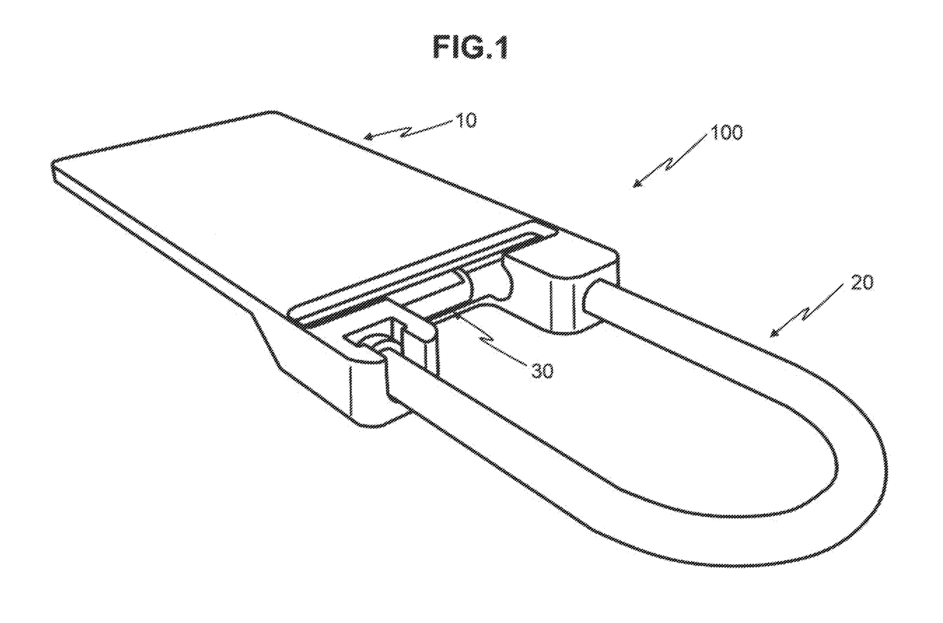

Referring to FIGS. 1-4, there is disclosed an attachable mini whiteboard 100 according to one embodiment of the present invention which comprises a mini dry erase board or “whiteboard” 10 and a substantially U-shaped re-bendable attachment loop 20. The mini whiteboard 10 is substantially rectangular with rounded corners. The whiteboard 10 has a front, back, top, bottom, two lateral sides and a writing surface 11 on the front side thereof on which the end user may erasably write down their messages by application of a dry erase maker. The whiteboard 10 has a receiving port or opening 13 for receiving the free second end 22 of the re-bendable attachment loop 20.

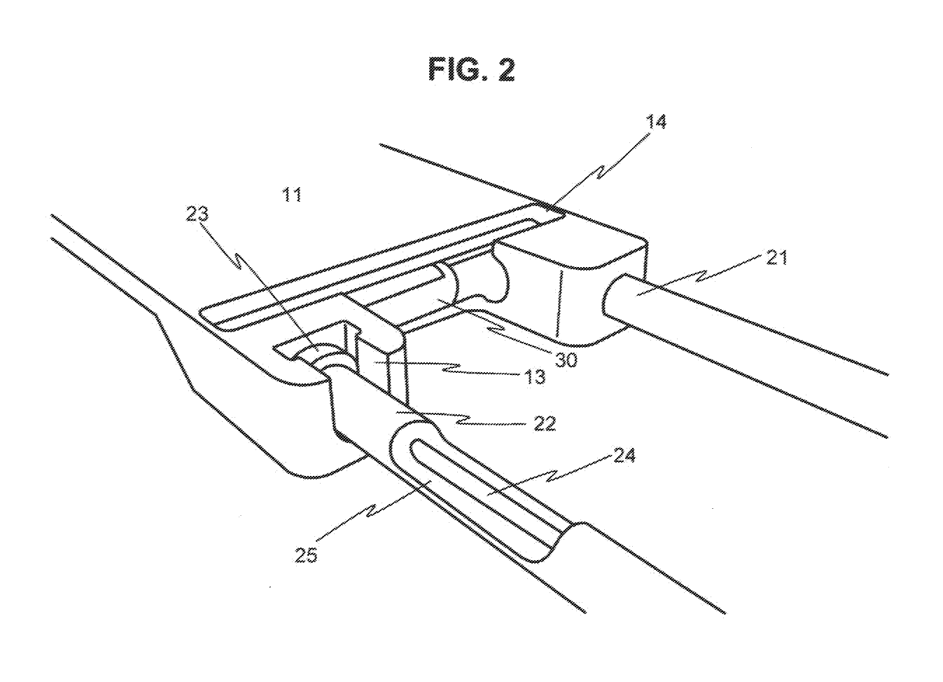

As shown in FIG. 2, the whiteboard 10 is structured so as to have a top corner that is permanently connected to a first end 21 of the attachment loop 20 and an opposite top corner that has a cutout receiving port 13 allowing for the second end 22 of the attachment loop 20 to attach and detach from the body of the whiteboard structure itself.

The whiteboard 10 further has a groove 14 which is a carved out portion of the front side along the top edge below where the loop attaches to the whiteboard for holding a whiteboard writing instrument such as dry erase marker 30 so that the dry erase marker may be securely held in place when not in use.

The whiteboard 10 can have a dimension that is about 6 inches, more or less in length, 2 inches, more or less in width, and a thickness of between one-half of an inch to one inch, more or less. The base member supports a clearance opening and notch at one top corner.

The first end 21 of the substantially U-shaped re-bendable attachment loop 20 is permanently (or integrally) connected to the top side of the whiteboard 10 and the second end 22 of the attachment loop 20 has complimentarily shaped structure 23 to mate with (or engage) the receiving port 13 on the mini whiteboard. The unique feature of this configuration enables the attachment loop 23 to easily get into and won't fall out of the receiving port 13.

The attachment loop 20 can be composed of plastic, metal, or any other material that is relatively bendable and able to retain its bent shape without breaking due to constant bending and reshaping. The attachment loop 20 has a length that is about the length of the whiteboard itself while in a bent or looped position.

Referring to FIG. 2, there is shown a view of the upper portion of the overall device itself and a cross section of the attachment loop 20 wherein two structural elements of the looping device are visible. Seen herein, the attachment loop 20 consists of a wire 24 within a soft spongy like material 25 that completely encases the smaller inner wire itself. The properties of both layers are different. While the inner wire 24 serve to flex and bend into a verity of shapes with the use of light pressure by a human hand to such wire; the outer layer of the attachment loop 20 consists of a soft spongy like material 25 that is rubbery in nature and spongy to one's human touch. This allows for protection of the inner wire 24 as well as protection from scratching any handle or knob around which such device is removably attached.

The attachment loop 20 is adjustable; it can be in straight, twisted or bent form as needed so that it can be attached to a doorknob or cabinet handle or to stand on any flat surface. The unique feature (or aspect) of this attachment loop 20 makes possible for leaving notes from one person to another on doors in hotels, on doors of hospitals, or on file cabinets in offices, office workroom doors, conference room doors to reserve the room, etc. The attachable mini whiteboard of the present invention provides a quick way of leaving temporary information and having the ability to erase said information and reuse the whiteboard.

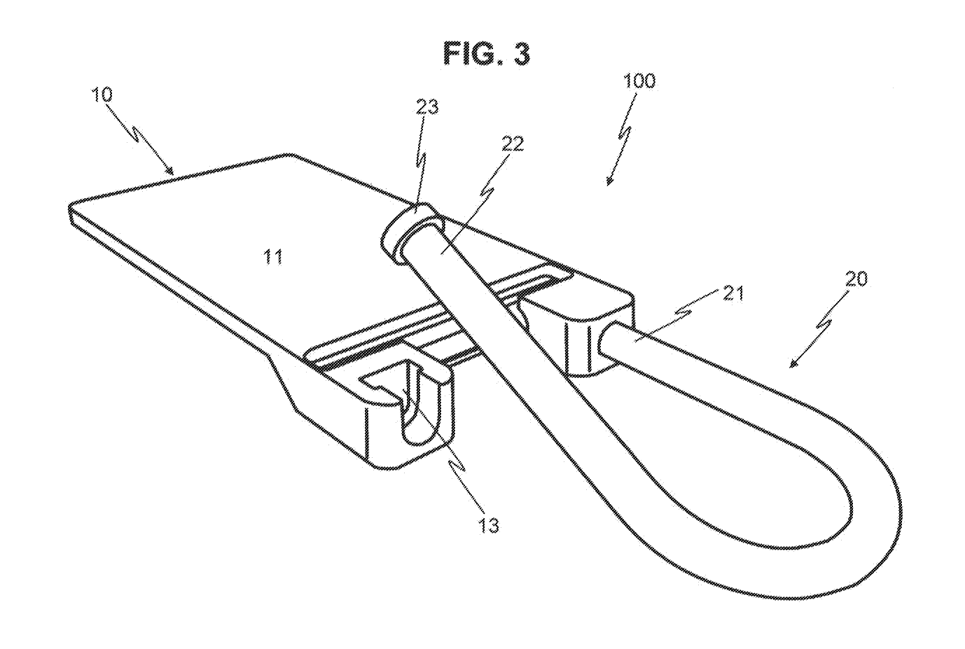

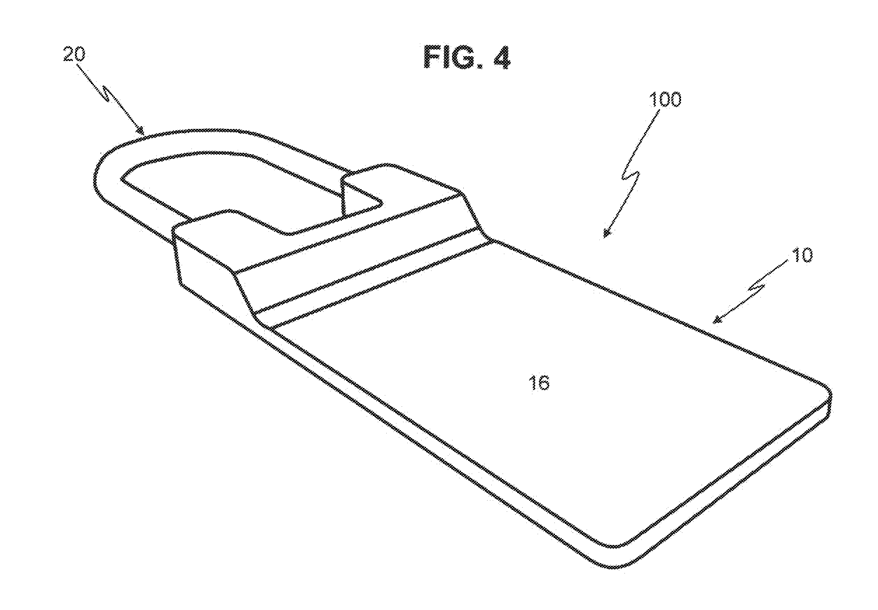

FIG. 3 is an isometric front view of the attachable mini whiteboard showing the attachment loop is twistable and bendable. In an embodiment shown in FIG. 3, the second end's structure 23 of the re-bendable wire can be easily slide into and stays inside the receiving port 13 and slide out of the receiving port along the plane perpendicular to the whiteboard writing surface 11. In this embodiment, a user of said device will unhook the one end of the looping device from the upper corner of the whiteboard structure itself. The looping device can then be looped over a door handle and reinserted into the overall structure and thereby creating a temporary connection with the handle itself. User can then write a note on the whiteboard for others to see. Here in FIG. 4 such note is a simple message from a child to her mother—“Love U Mom”.

Referring to FIG. 4, there is disclosed a back view of the attachable mini whiteboard with the unique attachment loop. Here the attaching upper side of the whiteboard for the looping device is seen as not having a hollow opening from the opposing front side of the whiteboard. As such the open receiving port 23 for the second end 22 of the attachment loop 20 is a carved out structure that is open on the front side of the overall device but said carve out structure does not have an opening through the back side of the overall device itself. Therefore, the second end 22 of the attach loop 20 stays in the receiving port 13 and won't slip out when bent back to stay on the desk or hang on the door knob.

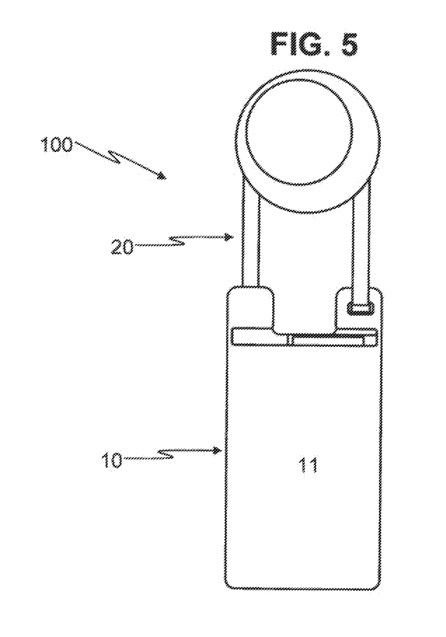

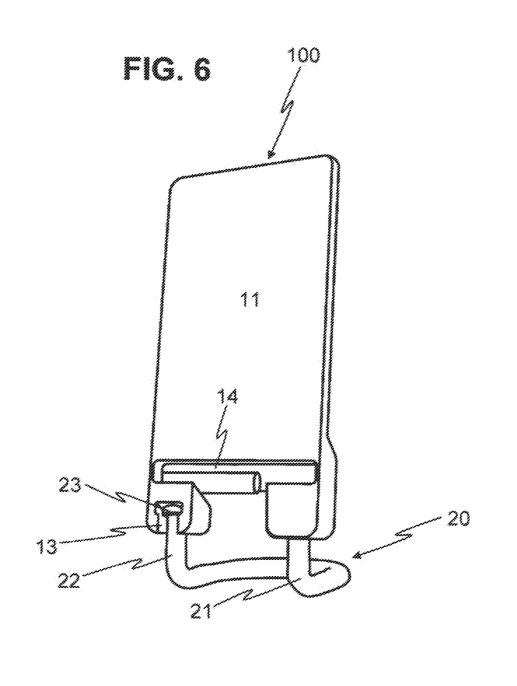

FIG. 5 is a front view showing that the attachable mini whiteboard of the present invention is hung on a doorknob with its attachment loop 20 in a straight form. FIG. 6 shows a front view that the attach loop 20 can be bent to allow for the whiteboard to stand upright on a table so that the message written on the whiteboard is easily spotted and thus won't be missed. In addition, this device could be used in a restaurant to show changing menu items to guests at their table and be positioned in a standing position on the table for ease of viewing.

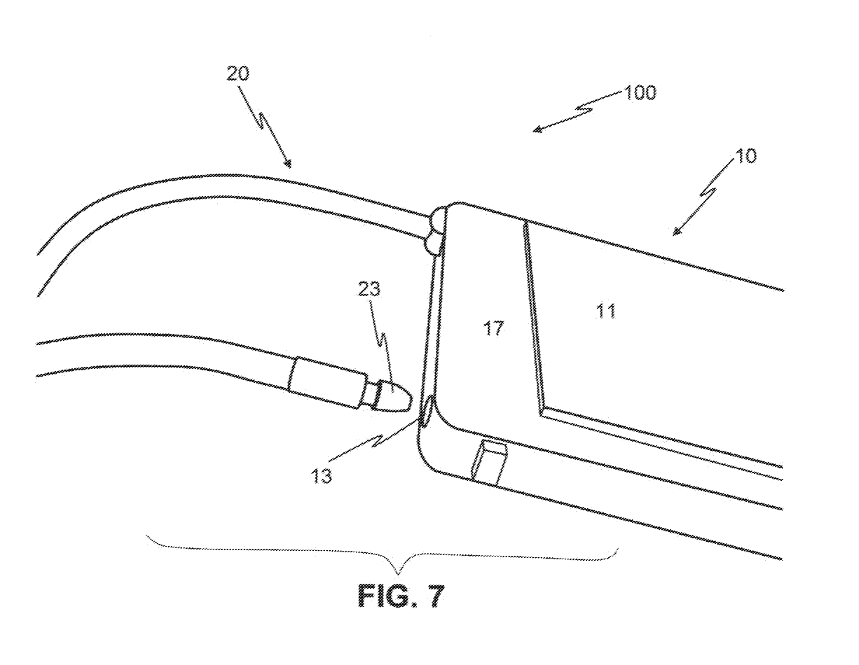

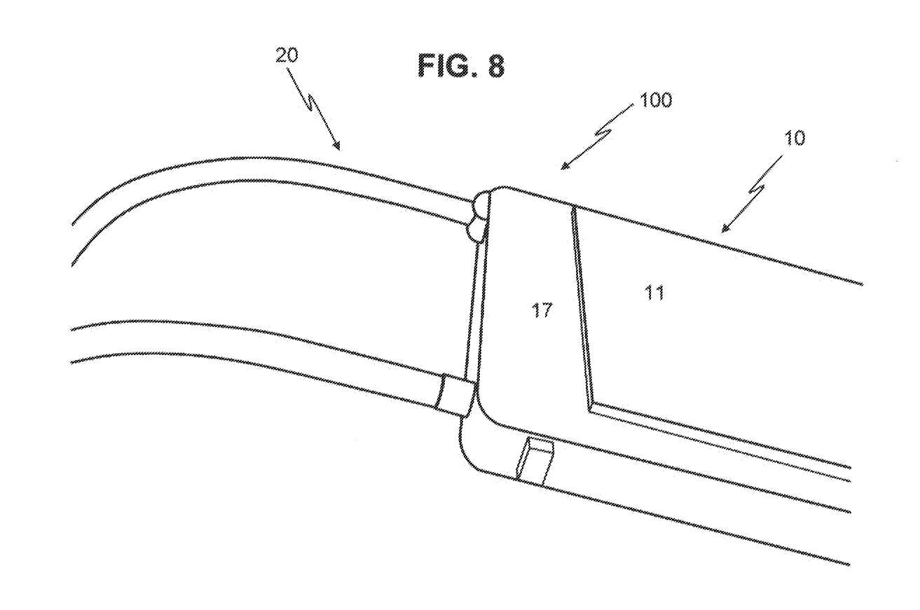

FIGS. 7-8 are isometric front views showing part of the attachable mini whiteboard 100 according to another embodiment of the present invention. The attachable mini whiteboard 10 has a backboard 17 and a dry erase writing surface 11 on its front. The second end's head 23 of the attachment loop 20 can be inserted into an opening 13 on the whiteboard along the imaginary plane parallel to the whiteboard writing surface 17.

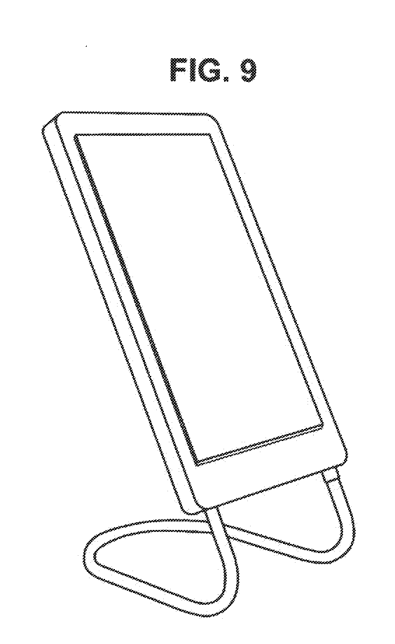

FIG. 9 is an isometric view of the embodiment placed on a flat surface.

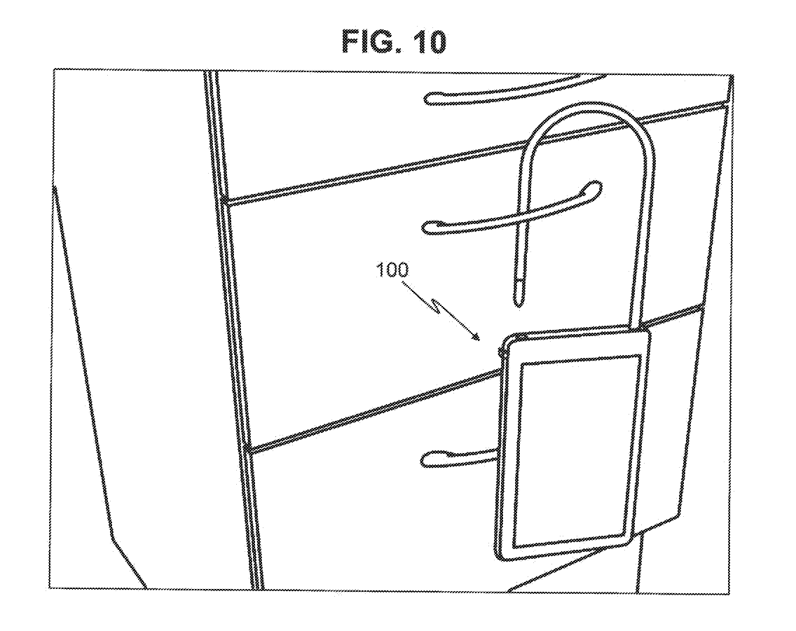

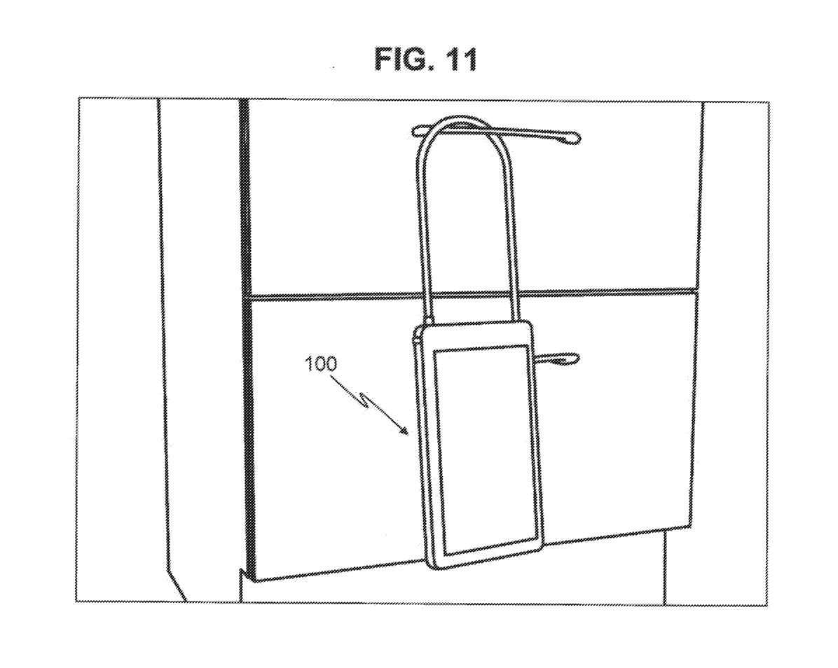

FIGS. 10-11 are front views showing the attachable mini whiteboard is hung on a handle of a cabinet.

Depending on the purpose of the device, the whiteboard may have different shapes and sizes. In a preferred embodiment, the whiteboard is substantially rectangular shape with round corners.

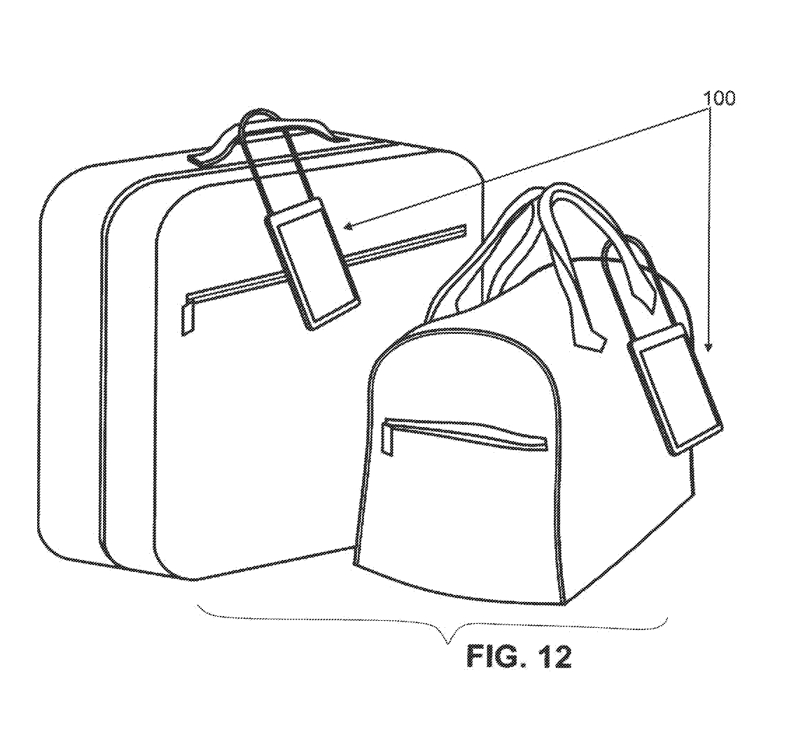

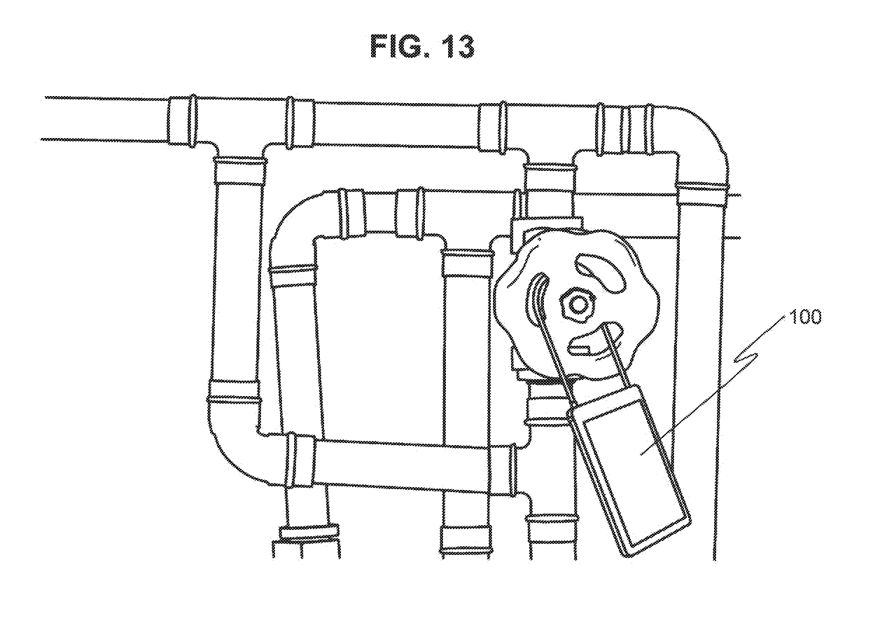

Referring to FIGS. 12 and 13 there is disclosed an attachable mini whiteboard 100 used for a mini labeling tag for luggage and plumbing pipes. The device is smaller in size relative to the device used to be placed on a desk or hung on a doorknob or furniture or any place that can be attached to.

The attachable mini whiteboard 100 of the present invention may have permanently imprinted logos or messages on the dry erase writing surface or other parts for commercial advertisement purposes. For example, the attachable mini whiteboard used in hotels can carry the hotels' logo and carry the flight airlines' logos if used as luggage tags. For tagging plumbing pipes, predetermined check boxes may be imprinted on the writing surface for functional purposes.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. An attachable mini whiteboard with an attachment loop comprising:
a mini whiteboard having a front and back sides, a dry erase writing surface on the front side, a groove along an edge of the whiteboard for holding a whiteboard writing instrument in place, and a receiving port; and
an attachment loop having a first end and a second end, the first end being permanently connected to the mini whiteboard and the second end having a complementarily shaped structure of the receiving port in order to mate with and engage the receiving port of the whiteboard;
wherein the attachment loop has a flexible inner wire such that the attachment loop is bendable as needed to fit mounting surface.

2. The attachable mini whiteboard of claim 1, wherein the second end of the attachment loop engages the receiving port along the plane parallel to the writing surface.

3. The attachable mini whiteboard of claim 1, wherein the second end of the attachment loop engages the receiving port along the plane perpendicular to the writing surface.

4. The attachable mini whiteboard of claim 1, wherein the flexible inner wire is encased by soft rubber like resilient material.

6. The attachable mini whiteboard of claim 1, further comprising a whiteboard writing instrument including a dry erase marker.

7. The attachable mini whiteboard of claim 1 further comprising permanently imprinted logos or messages on the dry erase writing surface for commercial advertisement or functional purpose.

8. The attachable mini whiteboard of claim 1, wherein the attachment loop can be attached to or placed on any mounting surface including doorknobs, furniture, luggage, plumbing pipes, and any flat surfaces.

9. The attachable mini whiteboard of claim 1, wherein the mini whiteboard is made in one of a variety of sizes and shapes.

10. The attachable mini whiteboard of claim 1, wherein the mini whiteboard is substantially rectangular with round corners.

11. A portable pocket sized whiteboard with an upper flexible looping structure attached at both ends to the upper two corners of the body of the whiteboard structure and with an opening on its top side for storage of a whiteboard writing instrument comprising:
a flexible looping structure that is flexible with minimal force and with the ability to retain said bent shape;
a soft sponge like outer wrapping around a metal like flexible inner wire;
wherein said flexible looping structure is permanently attached at one corner of the upper portion of the whiteboard; and
said flexible looping structure is removably attached at an opposite end from the permanently attached end to the opposite upper corner of whiteboard structure where receiving port is located;
wherein said whiteboard with flexible looping device performs the functions of being a whiteboard, and being able to attach to a door knob or door handle and hang from said door knob or door handle.

12. The portable pocket sized whiteboard with an upper flexible looping structure of claim 11, wherein the whiteboard is approximately 6 inches in length, 2 inches in width, and between one-half of an inch to one inch in thickness.

13. The portable pocket sized whiteboard with an upper flexible looping structure of claim 11, wherein the looping structure has a length that is about the length of the whiteboard itself while in a bent or looped position.

14. The portable pocket sized whiteboard with an upper flexible looping structure of claim 11, wherein the looping device can be composed of plastic, metal, or any other material that is relatively bendable and able to retain its bent shape without breaking due to constant bending and reshaping.
